(19) United States
(12) Patent Application Publication
(10) Pub. No.: US 2026/0034018 A1
(43) Pub. Date: Feb. 5, 2026

(54) SPLIT SLIDING ROD STRUCTURE APPLIED TO MASSAGE HEAD

(71) Applicant: Zhejiang Red And Black Technology Co., Ltd., Lishui (CN)

(72) Inventors: Xinyi Shu, Jinyun (CN); Lifeng Shu, Kinyun (CN)

(21) Appl. No.: 18/822,117

(22) Filed: Aug. 31, 2024

(30) Foreign Application Priority Data
Aug. 1, 2024 (CN) 2024218607910

(51) Int. Cl. A61H 7/00

(52) U.S. Cl. CPC A61H 7/00; A61H 2201/0107; A61H 2201/0165; A61H 2201/1664

(57) ABSTRACT

A split sliding rod structure applied to a massage head includes a sliding rod support and a sliding cylinder. The sliding rod support abuts against and is connected to an end of the sliding cylinder, and a connecting column is arranged at an end of the sliding rod support. The connecting column is provided with an external thread, and the massage head is provided with an internal thread. The connecting column is in threaded connection with the massage head. The sliding rod support is directly connected to the massage head, and is in stable threaded connection with the internal thread of the massage head through an external thread on the sliding rod support. This split arrangement simplifies machining steps. The plastic support and a thread structure are directly injection-molded, and the sliding rod is implemented by turning a hollow aluminum profile, saving materials and reducing machining costs.

### TECHNICAL FIELD

The present disclosure relates to the field of massage devices, and in particular, to a split sliding rod structure applied to a massage head.

### BACKGROUND

In the field of design and manufacture of massagers and accessories thereof, as a sliding rod structure is used as an important component for connection and transmission, design rationality of the sliding rod structure is directly related to performance, cost-effectiveness and production efficiency of products. A conventional massage head and sliding rod structure is often of an integral design, that is, a sliding rod, a support, and other components are integrally machined and formed. Although this design ensures stability of the structure to a certain extent, this design has many shortcomings.

The integral design leads to complicated machining steps, and especially when the sliding rod needs to be made of a special material (such as a solid aluminum rod), the machining difficulty and cost increase significantly. In addition, the integrated structure lacks flexibility in material selection, and it is difficult to optimize materials based on functional requirements of different parts, resulting in a material waste.

### SUMMARY

In view of the above situation, it is necessary to provide a split sliding rod structure applied to a massage head to solve at least one of the above problems. The structure includes a sliding rod support and a sliding cylinder, where the sliding rod support abuts against and is connected to an end of the sliding cylinder, a connecting column is arranged at an end of the sliding rod support, the connecting column is provided with an external thread, the massage head is provided with an internal thread, and the connecting column is in threaded connection with the massage head.

Preferably, the sliding rod support is of a hollow design.

Preferably, the massage head is provided with a sealing rubber ring.

Preferably, a pin hole is provided at an end of the sliding rod support away from the connecting column, in a direction perpendicular to the connecting column.

Preferably, a sealing member is sleeved at a position where the massage head abuts against the sliding cylinder.

Preferably, the sliding rod support is further provided with a through hole, and the through hole penetrates to the connecting column.

### BRIEF DESCRIPTION OF THE DRAWINGS

1. Sliding rod support; 2. Sliding cylinder; 3. Connecting column; 31. External thread; 4. Massage head; 41. Internal thread; 5. Sealing rubber ring; 6. Pin hole; 7. Sealing member; 8. Through hole.

FIG. 1 is a schematic structural diagram of a massage head, a sliding cylinder and a sliding rod support according to an embodiment of the present disclosure;

FIG. 2 is an exploded view of a massage head, a sliding cylinder and a sliding rod support according to an embodiment of the present disclosure;

FIG. 3 is an exploded view of a sliding cylinder and a sliding rod support according to an embodiment of the present disclosure;

FIG. 4 is a schematic structural diagram of a massage head according to an embodiment of the present disclosure; and

FIG. 5 is a sectional view of a massage head, a sliding cylinder and a sliding rod support according to an embodiment of the present disclosure.

### DETAILED DESCRIPTION OF THE EMBODIMENTS

In order to make the objective, technical solutions and advantages of the present disclosure clearer, a split sliding rod structure applied to a massage head according to the present disclosure is described in further detail below with reference to the accompanying drawings and embodiments. It should be understood that specific embodiments described herein are merely intended to explain the present disclosure, but are not intended to limit the present disclosure.

In the description of the present disclosure, unless otherwise specified, “a plurality of” means two or more. The directional or positional relationship indicated by the term such as “central”, “longitudinal”, “transverse”, “upper”, “lower”, “left”, “right”, “inside”, “outside”, “front end”, “rear end”, “head”, “tail”, “vertical”, “horizontal”, “top”, and “bottom” is the directional or positional relationship based on the accompanying drawings, and is merely intended to facilitate and simplify the description of the present disclosure, rather than to indicate or imply that the device or element referred to must have a particular direction and be constructed and operated in a particular direction. Therefore, this should not be construed as limiting the present disclosure. Moreover, the terms “first”, “second”, and “third” are merely used for description, and are not intended to indicate or imply relative importance.

In the description of the present disclosure, it should be noted that, unless otherwise clearly specified, meanings of terms “mount”, “connected with”, and “connected to” should be understood in a board sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand specific meanings of the above terms in the present disclosure based on a specific situation.

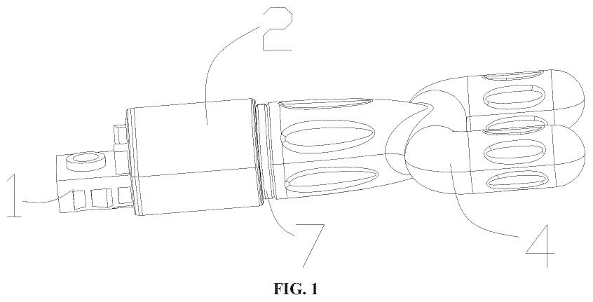

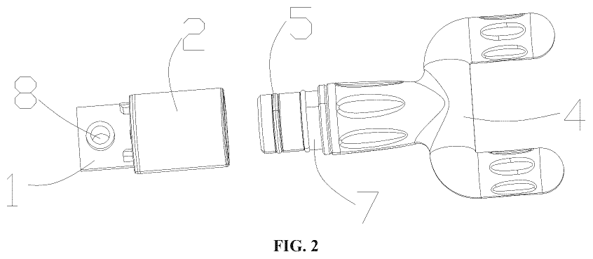

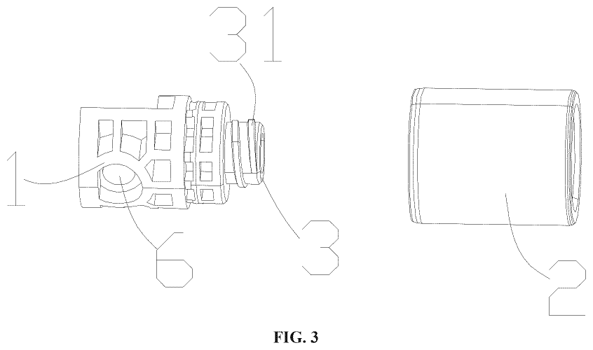

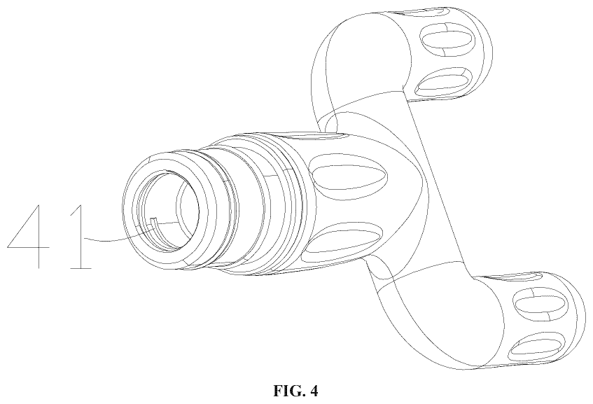

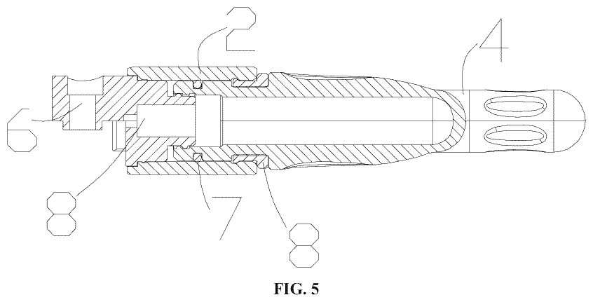

Referring to FIGS. 1 to 5, a split sliding rod structure applied to a massage head 4 according to an embodiment of the present disclosure includes a sliding rod support 1 and a sliding cylinder 2. The sliding rod support 1 abuts against and is connected to an end of the sliding cylinder 2, and a connecting column 3 is arranged at an end of the sliding rod support 1. The connecting column 3 is provided with an external thread 31, and the massage head 4 is provided with an internal thread 41. The connecting column 3 is in threaded connection with the massage head 4.

In the above embodiment, the structure includes the sliding rod support 1 and the sliding cylinder 2, which are closely connected by glue at one end in an abutting mode. The connecting column 3 extends out from an end of the sliding rod support 1, and the external thread 31 is directly injection-molded on the connecting column 3 and matches the preset internal thread 41 on the massage head. The connecting column 3 and the massage head 4 are firmly connected through rotation fit of the threads. This split design simplifies the machining process, and the sliding rod support 1 and a thread structure thereon can be completed in one injection molding process without additional machining procedures. In addition, the sliding cylinder 2 is implemented by turning a hollow aluminum profile, which reduces an overall weight, reduces material costs and improves economic benefits.

Referring to FIGS. 1 to 5, the sliding rod support 1 is of a hollow design.

In the above embodiment, as the sliding rod support 1 is used as a key component of the split sliding rod structure of the massage head 4, the hollow design thereof aims to solve the common shrinkage problem in the injection molding process, optimize use of materials and reduce the overall weight. In injection molding, plastic may be deformed due to volume shrinkage during cooling and solidification, especially in a thick-walled part. With the hollow design, that is, with a certain number of holes or a hollow structure provided inside the support, the thickness of the material can be effectively reduced, and the volume shrinkage during cooling can be reduced, thereby avoiding deformation of the support caused by shrinkage.

Referring to FIGS. 1 to 5, the massage head 4 is provided with a sealing rubber ring 5.

In the above embodiment, the sealing rubber ring 5 is closely attached between the massage head 4 and a connecting component, thereby effectively preventing moisture, dust or other impurities from infiltrating into the massage head 4 and ensuring cleanliness and the service life of the massage head 4.

Referring to FIGS. 1 to 5, a pin hole 6 is provided at an end of the sliding rod support 1 away from the connecting column 3, in a direction perpendicular to the connecting column 3.

In the above embodiment, the pin hole 6 is provided mainly to cooperate with a pin or other fixing members, so as to more stably mount the sliding rod support 1 on a power component of a massage device. This vertical layout not only enhances the stability of the sliding rod support 1, but also ensures that the sliding rod support can uniformly transmit a force when stressed, thereby reducing the risk of damage caused by stress concentration.

Referring to FIGS. 1 to 5, a sealing member 7 is sleeved at a position where the massage head 4 abuts against the sliding cylinder 2.

In the above embodiment, the sealing member 7 is arranged on an interface where the massage head 4 is in contact with the sliding cylinder 2, and an outer edge of the sealing member is closely attached to surfaces of the massage head and the sliding cylinder, thereby forming an effective sealing barrier. This barrier can effectively prevent external impurities such as moisture and dust from invading internal structures of the massage head 4 and the sliding cylinder 2, and keep internal environments clean and dry, thereby prolonging the service life of a massage device. In addition, the sealing member 7 further achieves a certain buffering and shock absorption effect. When the massage head 4 moves back and forth along the sliding cylinder 2, the sealing member 7 can absorb part of an impact force and vibration, reduce noise and wear caused by friction, and improve stability and comfort during massage.

Referring to FIGS. 1 to 5, the sliding rod support 1 is further provided with a through hole 8, and the through hole 8 penetrates to the connecting column 3.

In the above embodiment, the through hole 8 penetrates to the connecting column 3, thereby providing a direct channel for a wire to pass through.

The above descriptions are only preferred embodiments of the present disclosure, and are not intended to limit the present disclosure in any form. Although the present disclosure has been disclosed by the preferred embodiments above, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification and equivalent change made to the foregoing embodiments according to the technical essence of the present disclosure without departing from the content of the technical solution of the present disclosure shall fall within the scope of the technical solution of the present disclosure.

What is claimed is:

1. A split sliding rod structure applied to a massage head, comprising a sliding rod support and a sliding cylinder, wherein the sliding rod support abuts against and is connected to an end of the sliding cylinder, a connecting column is arranged at an end of the sliding rod support, the connecting column is provided with an external thread, the massage head is provided with an internal thread, and the connecting column is in threaded connection with the massage head.

2. The split sliding rod structure applied to a massage head according to claim 1, wherein the sliding rod support is of a hollow design.

3. The split sliding rod structure applied to a massage head according to claim 1, wherein the massage head is provided with a sealing rubber ring.

4. The split sliding rod structure applied to a massage head according to claim 1, wherein a pin hole is provided at an end of the sliding rod support away from the connecting column, in a direction perpendicular to the connecting column.

5. The split sliding rod structure applied to a massage head according to claim 1, wherein a sealing member is sleeved at a position where the massage head abuts against the sliding cylinder.

6. The split sliding rod structure applied to a massage head according to claim 1, wherein the sliding rod support is further provided with a through hole, and the through hole penetrates to the connecting column.
